(19) United States
(12) Patent Application Publication
(10) Pub. No.: US 2015/0035729 A1
(43) Pub. Date: Feb. 5, 2015

(54) OLED DISPLAY PANEL

(71) Applicant: Ye Xin Technology Consulting Co., Ltd., Hsinchu (TW)

(72) Inventor: CHUN-CHIEH HUANG, Hsinchu (TW)

(73) Assignee: YE XIN TECHNOLOGY CONSULTING CO., LTD., Hsinchu (TW)

(21) Appl. No.: 13/974,055

(22) Filed: Aug. 23, 2013

(30) Foreign Application Priority Data
Aug. 5, 2013 (TW) 102127958

(51) Int. Cl. G09G 3/32

(52) U.S. Cl. CPC G09G 3/3225
USPC 345/76

(57) ABSTRACT

An OLED display panel includes a plurality of spaced first pixels and a plurality of spaced second pixels arranged in rows and columns. Each of the first pixels includes a first sub-pixel, a second sub-pixel and a third sub-pixel. The first sub-pixel, the second sub-pixel and the third sub-pixel of each first pixel are substantially parallel to and spaced from each other. Each of the second pixels includes a first sub-pixel, a second sub-pixel and a third sub-pixel. The first sub-pixel, the second sub-pixel and the third sub-pixel of each second pixel are substantially parallel to and spaced from each other. The first pixels and the second pixels are arranged in alternate pattern in one row, and the first pixels and the second pixels are arranged in alternate pattern in one column

### BACKGROUND

1. Technical Field

The present disclosure relates to an OLED (organic light emitting diode) display panel.

2. Description of Related Art

OLEDs (organic light emitting diodes) are in development for use in displays. An OLED display panel includes a plurality of pixels. Referring to FIG. 1, each pixel includes three sub-pixels composed of red, green, and blue color, to generate a color image. For higher pixel density, the arrangement of the sub-pixels must be more compact, thereby increasing the burden of manufacturing the OLED display panel.

Therefore, an OLED display panel capable of overcoming the above described shortcomings is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a schematic view of a traditional OLED display panel.

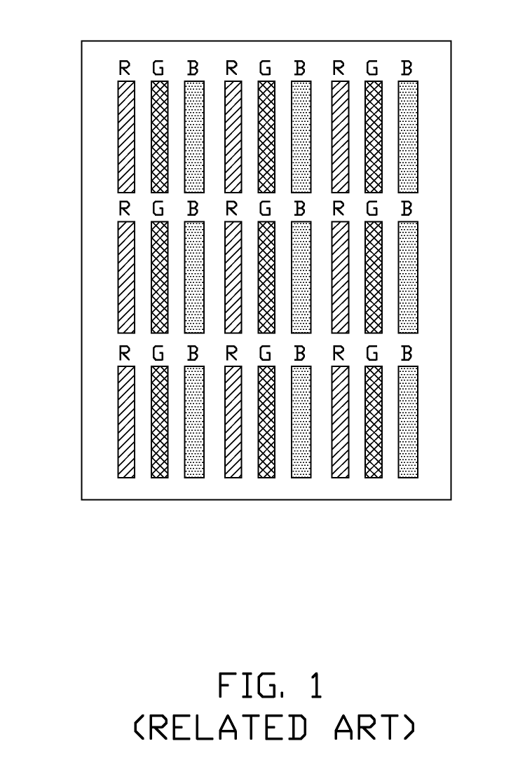

FIG. 2 shows a schematic view of an OLED display panel in accordance with an embodiment of the present disclosure.

### DETAILED DESCRIPTION

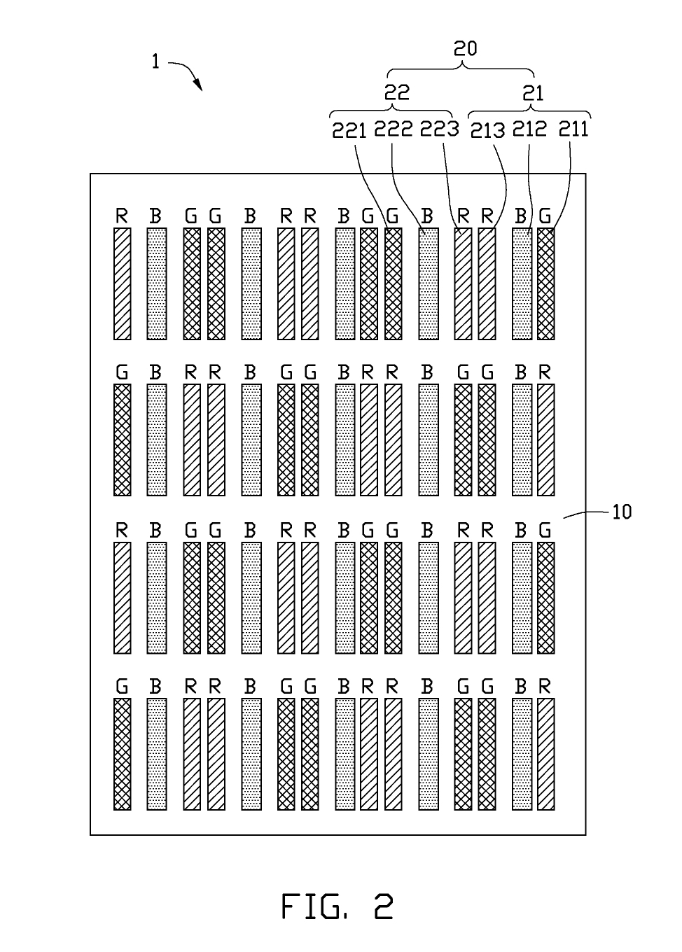

Referring to FIG. 2, an embodiment of an OLED display panel 1 includes a base 10 and a pixel array 20 formed on the base 10. The pixel array 20 includes a plurality of spaced first pixels 21 and a plurality of spaced second pixels 22 arranged in rows and columns. Each of the first pixels 21 includes a first sub-pixel 211, a second sub-pixel 212, and a third sub-pixel 213. The first sub-pixel 211, the second sub-pixel 212, and the third sub-pixel 213 are substantially parallel to and spaced from each other. Each of the second pixels 22 includes a first sub-pixel 221, a second sub-pixel 222, and a third sub-pixel 223. The first sub-pixel 221, the second sub-pixel 222, and the third sub-pixel 223 are substantially parallel to and spaced from each other. In this embodiment, the first sub-pixel 211 of the first pixel 21 is a green sub-pixel, the second sub-pixel 212 is a blue sub-pixel, and the third sub-pixel 213 is a red sub-pixel. The first sub-pixel 221 of the second pixel 22 is a green sub-pixel, the second sub-pixel 222 is a blue sub-pixel, and the third sub-pixel 223 is a red sub-pixel. The first sub-pixels 211, 221, the second sub-pixels 212, 222 and the third sub-pixels 213, 223 are not limited to being a green sub-pixel, a blue sub-pixel, or a red sub-pixel, as long as they are a different color from each other.

The first pixels 21 and the second pixels 22 are arranged in an alternating pattern in one row, and the arrangement of the first sub-pixel 211, the second sub-pixel 212, and the third sub-pixel 213 of each first pixel 21 is opposite to that of the first sub-pixel 221, the second sub-pixel 222 and the third sub-pixel 223 of each second pixel 22. For example, the arrangement of the first, second, and third sub-pixels 211, 212, 213 of one first pixel 21 is in a sequence of the third sub-pixel 213, the second sub-pixel 212, and the first sub-pixel 211 from left to right. The arrangement of the first, second, and third sub-pixels 221, 222, 223 of a left adjacent second pixel 22 is in a sequence of the first sub-pixel 221, the second sub-pixel 222, and the third sub-pixel 223 from left to right. Therefore, the two third sub-pixels 213, 223 of the first pixel 21 and the left second pixel 22 are adjacent to each other. Accordingly, the two first sub-pixels 211, 221 of the first pixel 21 and the right second pixel 22 are adjacent.

The first pixels 21 and the second pixels 22 are arranged in an alternating pattern in one column. In one column, the first sub-pixel 211 of one first pixel 21 is adjacent to the third sub-pixel 223 of one adjacent second pixel 22, and the third sub-pixel 213 of one first pixel 21 is adjacent to the first sub-pixel 221 of one adjacent second pixel 22. For example, referring to FIG. 2, the arrangement of the sub-pixels 211, 212, 213 of one first pixel 21 is in a sequence of the third sub-pixel 213, the second sub-pixel 212 and the first sub-pixel 211 from left to right, and the arrangement of the sub-pixels 221, 222, 223 of a lower adjacent second pixel 22 is in a sequence of the first sub-pixel 221, the second sub-pixel 222, and the third sub-pixel 223 from left to right.

For the third sub-pixels 223, 213 of the second pixel 22 and the right adjacent first pixel 21, and the first sub-pixels 221, 223 of the second pixel 22 and the left adjacent first pixel 21, a distance between the first pixel 21 and the adjacent second pixel 22 decreases.

Furthermore, the two first sub-pixels and the two third sub-pixels with the same color can be manufactured in one chamber by evaporation process. Thus, the width of the first sub-pixel and the third sub-pixel can be further decreased, and the resolution of the OLED display panel 1 is accordingly increased.

Particular embodiments are shown and described by way of illustration only.

The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An organic light emitting diode (OLED) display panel, comprising a plurality of spaced first pixels and a plurality of spaced second pixels arranged in rows and columns, wherein each of the first pixels comprises a first sub-pixel, a second sub-pixel, and a third sub-pixel; the first sub-pixel, the second sub-pixel, and the third sub-pixel of each first pixel being substantially parallel to and spaced from each other; each of the second pixels comprising a first sub-pixel, a second sub-pixel, and a third sub-pixel; and the first sub-pixel, the second sub-pixel and the third sub-pixel of each second pixel being substantially parallel to and spaced from each other; the first pixels and the second pixels are arranged in an alternating pattern in each row, and the first pixels and the second pixels are arranged in an alternating pattern in each column

2. The OLED display panel of claim 1, wherein in each first pixel, the first sub-pixel is a green sub-pixel, the second sub-pixel is a blue sub-pixel, and the third sub-pixel is a red sub-pixel.

3. The OLED display panel of claim 1, wherein in each second pixel, the first sub-pixel is a green sub-pixel, the second sub-pixel is a blue sub-pixel, and the third sub-pixel is a red sub-pixel.

4. The OLED display panel of claim 1, wherein the arrangement of the first sub-pixel, the second sub-pixel, and the third sub-pixel of each first pixel is opposite to that of the first sub-pixel, the second sub-pixel, and the third sub-pixel of each second pixel.

5. The OLED display panel of claim 1, wherein in the first pixel and an adjacent second pixel of the one row, the third sub-pixels of the first pixel and the second pixel are adjacent, or the first sub-pixels of the first pixel and the second pixel are adjacent.

6. The OLED display panel of claim 1, wherein in the first pixel and an adjacent second pixel of the one column, the first sub-pixel of the first pixel is adjacent to the third sub-pixel of the second pixel, and the third sub-pixel of the first pixel is adjacent to the first sub-pixel of the second pixel.
